(19) United States
(12) Patent Application Publication
(10) Pub. No.: US 2024/0097453 A1
(43) Pub. Date: Mar. 21, 2024

(54) GALVANICALLY ISOLATED ENERGY STORAGE - TIE INVERTER

(71) Applicant: SPOC Automation, Inc., Trussville, AL (US)

(72) Inventors: Andrew Williams, Bay St. Louis, MS (US); Ben Gully, Anacortes, WA (US); Morten Pederson, Fort Lauderdale, FL (US)

(73) Assignee: SPOC Automation, Inc., Trussville, AL (US)

(21) Appl. No.: 18/369,642

(22) Filed: Sep. 18, 2023

Related U.S. Application Data
(60) Provisional application No. 63/407,962, filed on Sep. 19, 2022.

(51) Int. Cl. H02J 3/46; H02M 7/797

(52) U.S. Cl. CPC H02J 3/46; H02M 7/797

(57) ABSTRACT

A marine vessel has AC generators and AC loads connected by circuit breakers to first and second AC bus systems respectively. First and second galvanic isolators, which include bidirectional AC/DC inverters are connected to each other and respectively connected to the first and second bus systems. As a result, power may be transferred to and from multiple galvanically isolated AC bus systems and to and from DC energy storage systems while maintaining DP-2 requirements.

### CROSS-REFERENCE TO RELATED APPLICATIONS

This application claims priority to U.S. Provisional Application No. 63/407,962, filed Sep. 29, 2022, which is incorporated by reference herein in its entirety.

### BACKGROUND

A vessel on the open seas is acted upon by external forces produced by wind, tides and waves. Dynamic positioning (DP) systems are known which enable a vessel that approaches a fixed offshore platform, such as an oil rig, windmill, etc., to avoid collision with the platform. A DP vessel will approach an offshore platform, get close without colliding with the platform, make continuous measuring of its position and the external forces acting on the vessel, and automatically compensate for any charges in position using its thruster(s) and stabilizers to maintain a fixed position or station. Standards for such DP systems include DP-1 providing only dynamic positioning, and DP-2 providing redundancy such that a single failure does not result in the loss of station maintenance. Many offshore platforms only permit vessels with a DP system to approach the platform and often a DP-2 system is required.

A DP vessel servicing an offshore platform will have a power plant and a large electrical system capable of operating all shipboard systems. The owners of offshore platforms have disallowed service vessels from using a closed bus tie due to fear of blackout. Specifically, fear that a single-point failure would cause the vessel to lose power, resulting in environmental or human tragedy.

### SUMMARY

An aspect of at least one of the embodiments described herein is to provide full redundancy of an electrical system of an offshore service vessel while maintaining DP-2 classification.

Another aspect of at least one of the embodiments is to provide a circuit that may be used for storing and transferring energy between galvanically isolated AC bus systems on offshore service vessels while the AC bus tie is open, while maintaining DP-2 classification.

Yet another aspect of at least one of the embodiments is to require lower power storage in a battery than in a system that does not allow transfer of power between isolated buses in a DP-2 system.

A further aspect of at least one of the embodiments is to provide a power distribution system able to be retrofitted into existing vessels, as well as new vessels.

Yet another aspect of at least one of the embodiments is to connect at least one energy storage device such as a battery system to each side of two AC buses, while transferring generator power from one AC bus to another, galvanically isolated AC bus.

A further aspect of at least one of the embodiments is to prevent a zero voltage condition on one bus to propagate to another bus while allowing power to transfer between buses via a galvanic isolator(s).

Yet another further aspect of at least one of the embodiments is to provide a power distribution system that enables a single generator to power all loads of a marine vessel during DP-2 operation.

A further aspect of at least one of the embodiments is to permit running a smaller generator on each isolated bus with the bus tie open and be able to transfer power to the other isolated bus, with or without energy storage, such that a worst case single point failure would only result in half of the ship's AC bus losing power.

Yet another further aspect of at least one of the embodiments is to enable batteries to be sized much smaller than in a system that does not allow transfer of power between the buses through inverters.

A further aspect of at least one of the embodiments is that the batteries, if included, can be used in the spinning reserve calculations for each bus.

Yet another aspect of at least one of the embodiments is to provide significantly enhanced operational capabilities for marine vessels in, e.g., IMO Class DP 2, etc.

### BRIEF DESCRIPTION OF DRAWINGS

These and other aspects and advantages will become more apparent and more readily appreciated from the following description of the exemplary embodiments, taken in conjunction with the accompanying drawings of which:

FIGS. 1-3 are a circuit diagrams of embodiments of a galvanically isolated energy storage-tie inverter.

### DETAILED DESCRIPTION OF EMBODIMENTS

Reference will now be made in detail to embodiments, examples of which are illustrated in the accompanying drawings. In this regard, the embodiments may have different forms and should not be construed as being limited to the descriptions set forth herein. To further clearly describe features of the embodiments, descriptions of other features that are well known to one of ordinary skill in the art are omitted here.

The articles “a”, “an” and “the” are intended to include both singular and plural forms of the following nouns. Phrases using the term “and/or” include a plurality of combinations of relevant items or any one item among a plurality of relevant items. The term “at least [number]” preceding a list of items denotes any combination of the items in the list that satisfies the expression. In the case of “at least one” the expression includes any one item among a plurality of the listed item(s), as well as multiple items. Expressions such as “at least one of,” when preceding a list of elements, modify the entire list of elements and do not modify the individual elements of the list.

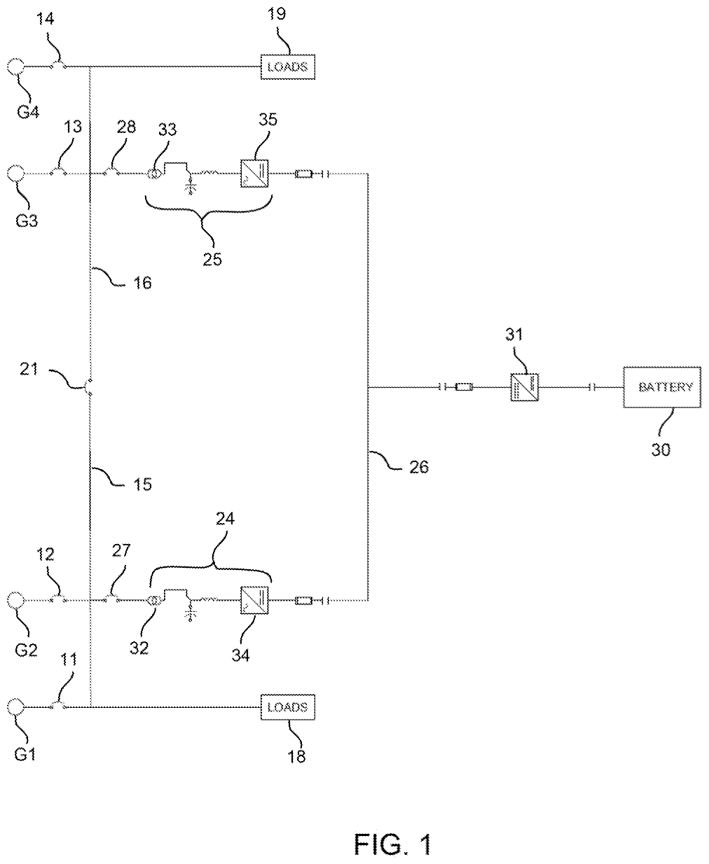

FIGS. 1-3 illustrate three embodiments of a system, connected to a typical offshore service vessel one-line, which serves the dual purpose of connecting energy storage devices such as battery systems to each side of a bus, as well as the ability to transfer generator power from one AC bus to another AC bus while the AC bus tie is open. This is possible by using bi-directional inverters that transfer power in either direction. In the illustrated embodiments, the transformers and inverters galvanically isolate the two AC bus systems. Therefore, a zero voltage condition on one bus cannot propagate to the other bus.

If energy storage is included, many different configurations are possible. In all cases, it is preferred that energy storage is connected onto a common DC link bus and that DC bus is then connected to two or more DC/AC inverters that feed back to the ship's AC bus system. This allows both stored energy, e.g., in batteries, as well as energy from one AC bus to be transferred to the other AC bus while galvanically isolated and with the AC bus tie open.

In the embodiments in FIGS. 1-3, optional DC to DC converters are illustrated. Pairing of these optional DC to DC converters with energy storage helps maintain the common DC link bus voltage at appropriate levels to maintain the correct AC voltage output to each of the galvanically isolated buses. These DC to DC converters also allow the operator to precisely control the charging and discharging of batteries.

The illustrated embodiments allow for the energy storage on a vessel to be immediately deployed on either AC bus while the AC bus tie is open. Thus energy storage may be utilized for spinning reserve calculations on both bus systems, not just one. This allows vessel operators to save fuel and maintenance costs by running a single generator on one bus or two smaller generators, one on each bus, utilizing the energy storage as spinning reserve.

In the illustrated embodiments, a single generator or two smaller generators can provide power to both isolated bus systems through the inverters. The inverter sizing takes into account both the required power transfer between buses as well as the output and charging capabilities of the energy storage if included.

In the embodiment illustrated in FIG. 1, first, second, third and fourth generators G1-G4 have outputs of alternating current (AC) and are connected by first, second, third and fourth generator circuit breakers 11-14 at the outputs of the first, second, third and fourth generators, respectively, to first and second AC buses 15, 16 only during non-critical operations (Not DP-2 etc.). The first and second generator circuit breakers 11, 12 connect the first and second generators G1, G2 to the first AC bus 15 and the third and fourth generator circuit breakers 13, 14, connect the third and fourth generators G3, G4 to the second AC bus 16. AC bus 15 is connected to loads 18 that may use AC power directly from bus 15 connected to generators G1 or G2 or power from bus 16 after conversion (through galvanic isolators and inverters) AC to DC to AC. AC bus 16 is connected to loads 19 that may use AC power directly from bus 16 connected to generators G3 or G4 or power from bus 15 after conversion (through galvanic isolators and inverters) AC to DC to AC.

A normally open bus-tie circuit breaker 21 connects the first and second AC buses 15, 16. First and second galvanic isolators 24, 25 are connected together by (first) DC bus 26 and respectively connected to the first and second AC buses 15, 16 by first and second isolator connection circuit breakers 27, 28. When bus-tie circuit breaker 21 is open, the first and second AC buses 15, 16 are isolated from one another which prevents a failure on one bus from causing a failure on the other bus. When both isolator connection circuit breakers 27, 28 are closed, the first and second AC buses 15, 16 are connected by the first and second galvanic isolators 24, 25 which are bi-directional. As a result, any of the generators G1-G4 can supply power to either of the loads 18, 19 regardless of whether the bus-tie circuit breaker 21 is open or closed, provided both isolator connection circuit breakers 27, 28 are closed.

Each of the DC busses 26,40 shown in FIG. 1, 2, 3, may have multiple battery systems (not shown) connected to each bus and may have additional contactors or circuit breakers to provide additional isolation between power sources and the AC buses 15,16.

In the embodiment illustrated in FIG. 1, DC bus 26, connecting first and second galvanic isolators 24, 25, optionally may be connected to energy storage 30, such as a battery, by a DC/DC converter 31 if required by different voltages on the DC bus 26 and battery 30. When the circuit illustrated in FIG. 1 is part of the power supply system of a marine vessel, a single generator can be operated with the bus-tie circuit breaker 21 open and have power available from battery 30 on both AC busses 15, 16. In the embodiment illustrated in FIG. 1, the single generator can provide power to both loads 18, 19 which are isolated by the first and second galvanic isolators 24, 25 when the bus-tie circuit breaker 21 is open. In this embodiment, a worst case single point failure would only result in half of the ship's AC bus losing power.

The first and second galvanic isolators 24, 25, when paired with energy storage 30, help maintain the common DC link bus voltage at appropriate levels to maintain the correct AC voltage output. The first and second galvanic isolators 24, 25 also allow the operator to precisely control charging and discharging of energy storage 30.

Each of the first and second galvanic isolators 24, 25 may include a transformer 32 or 33. The system may also include inverters 34, 35 that also provide some galvanic isolation. Each of the inverters 34, 35 may be an insulated-gate bipolar transistor inverter or technology with similar capability that is sized by taking into account both the required power transfer between buses as well as the output and charging capabilities of the battery 30. In the embodiment illustrated in FIG. 1 the power storage in battery 30 can potentially be smaller than in a system that does not allow transfer of power between first and second AC buses 15, 16 through first and second galvanic isolators 24, 25 and inverters 34, 35. In addition, battery 30 can be used in the spinning reserve calculations for each bus.

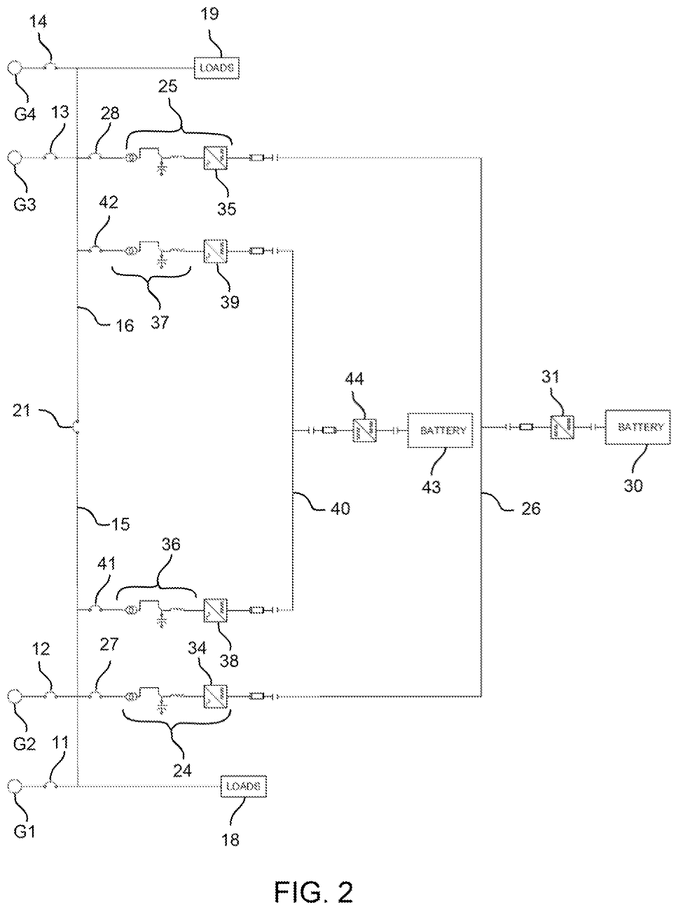

In the embodiment illustrated in FIG. 2, additional redundancy is provided to the electrical power system illustrated in FIG. 1. Third and fourth galvanic isolators 36, 37 and third and fourth AC/DC inverters 38, 39 are connected together by a second DC bus 40 and respectively connected to the first and second AC buses 15, 16 by third and fourth isolator connection circuit breakers 41, 42. Optionally, a second battery 43 may be connected to DC bus 40 by a second DC/DC converter 44, if required by different voltages on the DC bus 40 and battery 43.

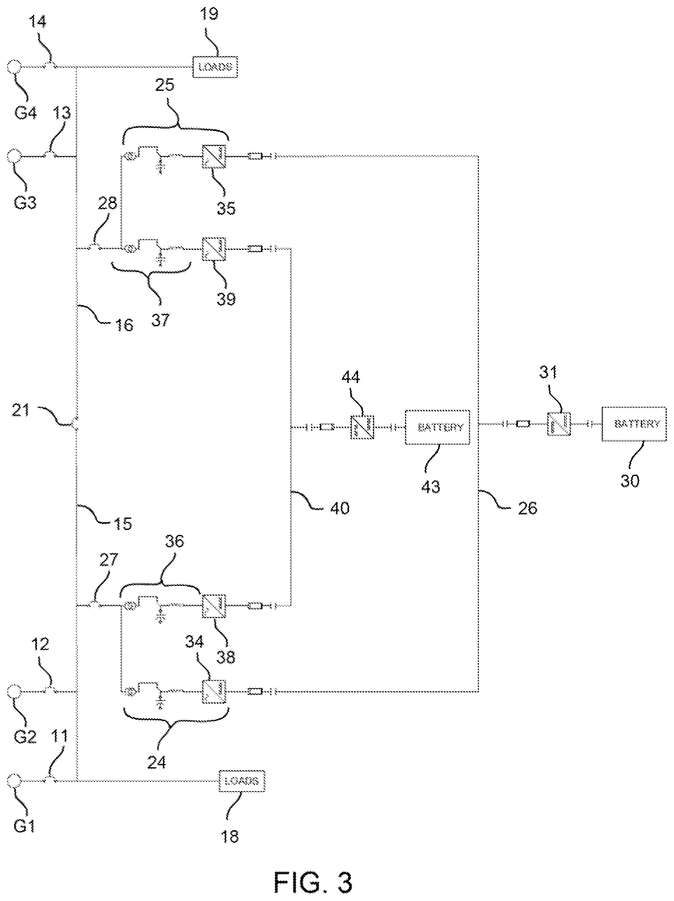

An alternative way of making the dual galvanically isolated connections to the first and second AC busses 15, 16 is illustrated in FIG. 3. Instead of providing third and fourth isolator connection circuit breakers 41, 42 to connect the third and fourth galvanic isolators 36, 37 to the first and second AC buses 15, 16, the third and fourth galvanic isolators 36, 37 are connected by the same first and second isolator connection circuit breakers 27, 28 that connect the first and second galvanic isolators 24, 25 to the first and second AC buses 15, 16.

In the embodiments illustrated in FIGS. 2-3, if two energy sources are included as depicted, the vessel owner will be able to run either a single generator or no generators with the bus tie open and have redundant power available on each bus. If the vessel is run on batteries only this will be only for a limited amount of time before recharging is necessary and this will be based on the KWH capacity of the batteries.

The many features and advantages of the embodiments are apparent from the detailed specification and, thus, it is intended by the appended claims to cover all such features and advantages of the embodiments that fall within the true spirit and scope thereof. Further, since numerous modifications and changes will readily occur to those skilled in the art, it is not desired to limit the inventive embodiments to the exact construction and operation illustrated and described, and accordingly all suitable modifications and equivalents may be resorted to, falling within the scope thereof.

What is claimed is:

1. An electrical power system for at least first and second loads, comprising:
first and second generators having outputs;
first and second circuit breakers at the outputs of the first and second generators connecting the first and second generators to the first and second loads, respectively; and
first and second galvanic isolators, connected together and respectively connected to the first and second loads.

2. The electrical power system according to claim 1, wherein each of the first and second galvanic isolators includes a bi-directional converter between alternating current and direct current.

3. The electrical power system according to claim 2, further comprising:
a DC bus connecting the first and second galvanic isolators; and
an energy storage connected to the DC bus.

4. The electrical power system according to claim 3, further comprising a DC/DC converter connecting the energy storage to the DC bus.

5. The electrical power system according to claim 4, wherein each of the first and second galvanic isolators includes an inverter and a transformer.

6. An electrical power system for at least first and second loads, comprising:
first, second, third and fourth generators having outputs;
first and second AC buses respectively connected to the pair of loads;
a bus-tie circuit breaker connecting the first and second AC buses;
first, second, third and fourth generator circuit breakers at the outputs of the first, second, third and fourth generators, respectively, the first and second generator circuit breakers connecting the first and second generators to the first AC bus and the third and fourth generator circuit breakers connecting the third and fourth generators to the second AC bus, the first and fourth generator circuit breakers connecting the first and fourth generators to the first and second loads, respectively; and
first and second galvanic isolators, connected together and respectively connected to the first and second AC buses.

7. The electrical power system according to claim 6, wherein each of the first and second galvanic isolators includes a bi-directional converter between alternating current and direct current.

8. The electrical power system according to claim 7, further comprising:
a first DC bus connecting the first and second galvanic isolators; and
a first energy storage connected to the first DC bus.

9. The electrical power system according to claim 8, further comprising a first DC/DC converter connecting the first energy storage to the first DC bus.

10. The electrical power system according to claim 9, further comprising:
third and fourth galvanic isolators providing bi-directional conversion between alternating current and direct current, each having first and second terminals, the first terminal of the third galvanic isolator connected to the first loads, and the first terminal of the fourth galvanic isolator connected to the second loads;
a second DC bus connecting the second terminals of the third and fourth isolators; and
a second energy storage connected to the second DC bus.

11. The electrical power system according to claim 10, further comprising a second DC/DC converter connecting the second energy storage to the second DC bus.

12. The electrical power system according to claim 11, wherein each of the first, second, third and fourth galvanic isolators includes a transformer.

13. The electrical power system according to claim 7, wherein each of the first and second galvanic isolators includes a transformer.

14. The electrical power system according to claim 7, further comprising third and fourth galvanic isolators providing bi-directional conversion between alternating current and direct current, each having first and second terminals, the first terminal of the third galvanic isolator connected to the first loads, the first terminal of the fourth galvanic isolator connected to the second loads, and the second terminals of the third and fourth galvanic isolators connected together.

15. The electrical power system according to claim 14, wherein each of the first, second, third and fourth galvanic isolators includes a transformer.

16. The electrical power system according to claim 14, further comprising first, second, third and fourth isolator connection circuit breakers, each having first and second terminals, the first terminals of the first and second isolator connection circuit breakers connected to the first AC bus, the first terminals of the third and fourth isolator connection circuit breakers connected to the second AC bus, and the second terminal of the first, second, third and fourth isolator connection circuit breakers connected to the first terminal of the first, second, third and fourth galvanic isolators, respectively.

17. The electrical power system according to claim 16, wherein each of the first, second, third and fourth galvanic isolators includes a transformer.

18. The electrical power system according to claim 14, further comprising first and second isolator connection circuit breakers, each having first and second terminals, the first terminals of the first and second isolator connection circuit breakers connected to the first and second AC buses, respectively, the second terminal of the first isolator connection circuit breaker connected to the first terminal of the first and third galvanic isolators, and the second terminal of the second isolator connection circuit breaker connected to the first terminal of the second and fourth galvanic isolators.

19. The electrical power system according to claim 18, wherein each of the first, second, third and fourth galvanic isolators includes a transformer.
